(19) United States
(12) Patent Application Publication
(10) Pub. No.: US 2017/0008673 A1
(43) Pub. Date: Jan. 12, 2017

(54) Decorated Container, Method and Facility for Producing Such a Container

(71) Applicant: ERCA, Les Ulis (FR)

(72) Inventors: Michel Kervazo, Saint Gervais (FR); Dominique Schwab, Versailles (FR); Tim Cooper, L'hay les Roses (FR)

(21) Appl. No.: 15/116,260

(22) PCT Filed: Feb. 4, 2015
(86) PCT No.: PCT/FR2015/050256

§ 371 Date: Aug. 3, 2016

(30) Foreign Application Priority Data
Feb. 5, 2014 (FR) 1450876

(51) Int. Cl. B65D 25/36; B29C 51/16; B65D 25/54

(52) U.S. Cl. CPC B65D 25/36; B65D 25/54; B29C 51/167; B29L 2031/712

(57) ABSTRACT

The container comprises a container body and a label placed on said body. The label has a window through which there can be seen decoration on the body of the container. In the method, before affixing the label on the body, a window is cut out in the label, and then the label is affixed in such a manner that a portion of the body is visible through said window, and decoration is made on said portion of the body of the container.

### CROSS REFERENCES TO RELATED APPLICATIONS

This application claims the priority benefit of PCT/FR2015/050256 filed on Feb. 4, 2015 and French Application No. 1450876 filed on Feb. 5, 2014. The contents of these applications are hereby incorporated by reference in their entirety

### FIELD OF THE INVENTION

The present invention relates to a container comprising a container body and a label placed on said body.

### BACKGROUND

In particular, the body of the container may be made by thermoforming using a sheet or panel of thermoplastic material. The label may be affixed on the body of the container while it is being formed, in particular during thermoforming, or else after forming. The label may take the form of a sheet covering a portion of the wall of the body, or also that of a band surrounding the body. The label has a useful function, indicating the nature of the product contained in the container, and other information, e.g. expiry date, etc. It also has an appearance function, carrying information such as distinctive images or signs, e.g. the brand name of the product contained in the container. With currently known containers, this information is indicated on the label. The visual appearance of the container as finally obtained is therefore determined both by the shape of the container and by the information carried by the label. There is thus relatively little potential in terms of design.

### SUMMARY OF THE INVENTION

The invention aims to provide a container in which the gamut of this potential is increased.

The aim is achieved by the fact that the label has a window through which there can be seen an image in relief forming decoration on the body of the container.

In this way, the body of the container can itself contribute to the final appearance that is obtained, by means of the decoration that can be seen on the portion of the body that is visible through the window.

In a variant, the body of the container is thermoformed.

In a variant, the label is a band that surrounds the body of the container.

In a variant, the window has a closed outline.

This closed outline makes it possible to reveal the portion of the container that is visible through the window by highlighting the decoration of the body of the container, thereby giving the container a visual appearance that catches the eye of the consumer.

Under such circumstances, the label carries an image and/or information that is flat, i.e. two dimensional, whereas the image in relief adds a third dimension and makes the combination particularly attractive to the eye of the consumer. In this example, the notion of an image should be understood broadly: it is a sign or a combination of signs such as letters, designs, or a combination of letters and designs, e.g. a logo.

The invention further relates to a method of manufacturing containers provided with a decorative label, wherein at least one container body is formed by thermoforming in a thermoforming chamber and a label is affixed on said body.

Such a method is known, e.g. from patents FR 2 790 705, FR 2 759 320, FR 2 858 263, or FR 2 945 470. For the above-mentioned reasons, the invention aims to provide a method that makes it possible to manufacture a container having a body that contributes more to the appearance that is finally obtained, in order to better catch the eye of the consumer.

This aim is achieved by the fact that, before affixing the label on the body, a window is cut out in the label, and then the label is affixed in such a manner that a portion of the body is visible through said window, and by the fact that decoration is made on said portion of the body of the container by a pattern in relief provided on a wall of said thermoforming chamber.

Thus, the method makes it possible, by means of steps that are simple, to obtain a container in which not only the label, but also the portion of the body that is visible through the window of said label, both contribute to distinguishing the container from other existing containers.

The decoration is made on the body of the container before affixing the label on said body.

This decoration may thus be made without any risk of damaging the label, and by decoration means that are different from those used for the label. The decoration may take the form of an image in relief and/or of a color image.

The decoration is made while the body of the container is being formed.

The decoration can thus be made without losing time in the process of manufacturing the container.

The pattern in relief may be made by shaping the wall of the thermoforming chamber or by placing an insert therein. During thermoforming, the thermoplastic material that is to form the body of the container comes naturally to press against said pattern, closely fitting against said relief, and thus forming an image that is the negative of the pattern in relief. This image is made while the container is being thermoformed and without increasing the time needed to manufacture the container, at least not in any substantial manner The term “pattern” should be understood broadly as covering any combination of signs and designs, making it possible to obtain an image, in agreement with the above definition of the term “image”.

In a variant, before the body of the container is formed, the label having the cut-out window is placed in said chamber.

The label may be placed in the chamber without lengthening the time required to manufacture the body, and since the label is placed in said chamber, the wall of the container is naturally pressed against it during thermoforming, without requiring an additional step of applying the label on the container. If needed, the inside face of the label that is to co-operate with the wall of the container body may be coated in a hot-melt material facilitating its adhesion to the body.

In a variant, the label is made in the form of a looped band cut from a ribbon.

The band presents the advantage of covering a large portion of the body of the container, and thus of being able to carry an image of large dimensions together with specific information. In the invention, the band has a window through which a portion of the body of the container is visible, which makes it possible to reveal decoration carried by said body, in particular when the window has a closed outline.

In a variant, a thermoforming mold is provided that has at least one row of thermoforming chambers, a label having a cut-out window is placed in each of the chambers of the row, and a container body is thermoformed in each of the chambers provided with a cut-out label.

The invention thus makes use of the decoration techniques of the type disclosed in the above-mentioned prior art documents, without lengthening the time required to manufacture the container body, and while also introducing a novel decorative element due to the pattern on the container body that can be seen through the window made in the label.

In a variant, while feeding a label strip to the thermoforming mold, at least one row of windows is cut out from the label strip, the label strip is cut apart into at least one row of ribbons each having one window of the row of windows, and a respective ribbon of the row of ribbons is fed to each of the thermoforming chambers of the row of chambers; for each ribbon of the row of ribbons, an end segment having a window is cut off and said segment is placed in a respective chamber of the row of chambers.

This makes it possible to work at high speeds, by performing certain operations in parallel with those required for manufacturing the container body. Making the windows before cutting apart the ribbons makes it possible to cut out the windows while the strip presents good strength and can be held in simple manner, without any risk of breaking or sliding relative to the window-cutting tool.

The invention further relates to an installation for manufacturing containers provided with respective decorative labels, the installation comprising at least one thermoforming chamber for forming the body of at least one container and means for affixing a label on said body.

As mentioned above, the invention aims to provide an installation making it possible to manufacture containers that provide greater potential for decoration than in the prior art.

This aim is achieved by the fact that the installation includes a windowing tool suitable for cutting out a window in the label before affixing the label with the window on the body, and means for making decoration on the portion of the body of the container that is visible through the window, the means for making decoration on the portion of the body that is visible through the window comprising a pattern in relief provided on a wall of the thermoforming chamber.

The installation uses simple means to obtain an innovative container in accordance with the intended aim of the invention.

The decoration is made without any substantial increase in the size of the installation and without affecting its rate of manufacture.

In particular, by means of the pattern in relief on the wall of the thermoforming chamber, the image of the portion of the body of the container that is visible through the window while thermoforming the containers is made without losing time and in particularly simple manner.

In a variant, the means for affixing the label on the body of the container comprise means for placing said label in the thermoforming chamber, before thermoforming of the container body.

As mentioned above, this makes it possible to secure the label to the body of the container during thermoforming.

Under such circumstances, in a variant, the installation includes means for feeding a label ribbon to the thermoforming chamber along a feed path; the windowing tool is placed on the feed path; and the installation includes, downstream from said windowing tool, a tool for cutting off an end segment from the label ribbon, and means for placing said segment in the thermoforming chamber.

This makes it possible to manufacture containers at a high rate.

Under such circumstances, in a variant, the installation includes a thermoforming mold having at least one row of thermoforming chambers, means for driving a label strip, splitting means for cutting apart at least one row of ribbons from the label strip, and a windowing station comprising at least one row of windowing tools; and the windowing station is placed upstream from the splitting means.

The windows may thus be made directly in the label strip, before it is split into a row of ribbons, and while the strip presents good strength and can be held efficiently for cutting out the windows.

### BRIEF DESCRIPTION OF THE DRAWINGS

The invention can be well understood and its advantages appear more clearly on reading the following detailed description of an embodiment shown by way of non-limiting example. The description refers to the accompanying drawings, in which:

FIG. 1 is a general view of an installation of the invention that makes it possible to manufacture containers;

FIGS. 2 and 3 show a window being cut out in a label strip;

FIG. 4 is a view analogous to FIG. 2, taken transversely;

FIG. 5 is a perspective view of a tool for cutting out windows in the label strip;

FIG. 6 is a diagram showing the tool for feeding labels into a thermoforming chamber;

FIG. 7 shows a container of the invention; and

FIG. 8 shows windows being cut out in a label strip, and label ribbons being fed to the thermoforming chambers.

### DETAILED DESCRIPTION

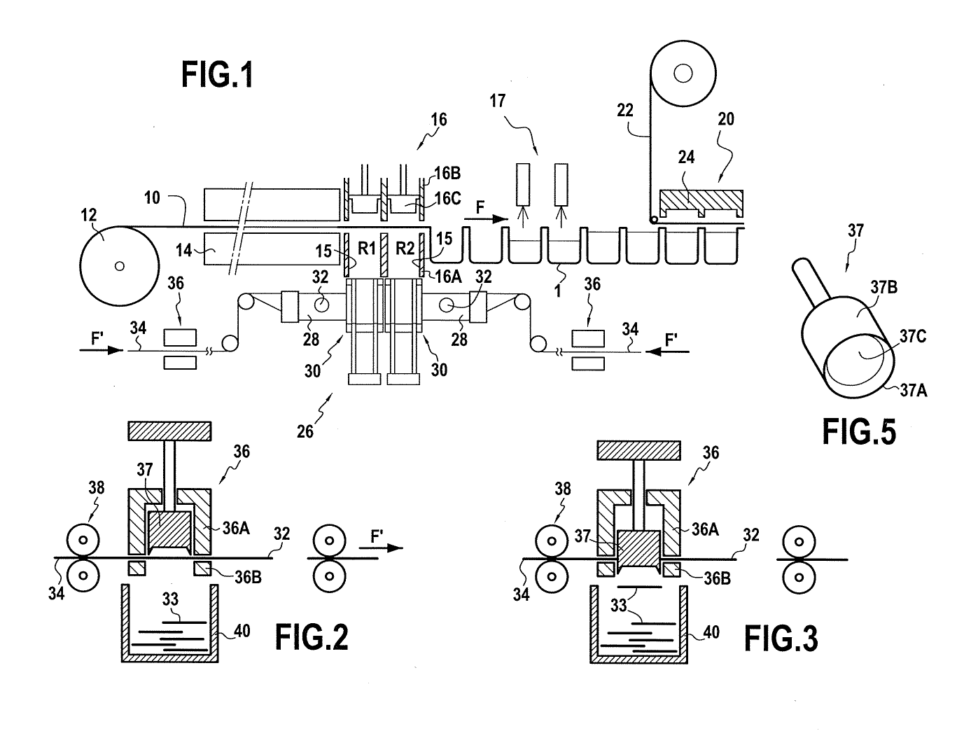

The installation of FIG. 1 serves to thermoform containers 1 from a thermoplastic strip 10 that is unwound from a coil 12 and that passes through, in general horizontally, the entire installation while being driven stepwise by support and drive means (not shown). In the remainder of the description below, the direction from upstream to downstream in the installation as indicated by arrow F must be understood as being the direction in which the strip advances through the various successive stations of the installation.

Thus, in the direction of arrow F, this installation comprises in succession a heating station 14 that serves to bring the thermoplastic strip up to the thermoforming temperature, a thermoforming station 16, in which the bodies of the containers are thermoformed and banded, a station for dosing and filling the containers 17, and a station for closing the containers 20, in which a lid strip 22 is placed on the open top end of the containers and is sealed at the edges of said containers by means of a sealing tool 24. Downstream from the station 20, the installation conventionally includes an installation for cutting out containers from the strip, then a station for packaging the containers, arranged by groups or individually.

The installation shown in FIG. 1 serves to process a row of containers in each station simultaneously. Naturally, some other number of rows, e.g. four, could be processed, as specified in Document FR 2 790 705.

In addition, in the example shown, the bodies of the containers are thermoformed from a continuous sheet 10. Naturally, the invention also applies to installations and methods in which the bodies of the containers are thermoformed from plates, individually or in groups.

In known manner, the thermoforming station 16 comprises a thermoforming mold 16A and a thermoforming backing tool 16B, comprising sleeves in which thermoforming pistons 16C are movable downwards and upwards in order to penetrate into the chambers 15 of the mold 16A (organized in this example into two rows R1 and R2) and to push the thermoplastic material down into the chambers.

The installation shown in FIG. 1 also comprises labeling means 26, specifically means for applying looped bands, which means are provided with means for feeding decorative ribbons 28 under the thermoforming chambers, and means 30 for inserting said ribbons into said chambers. As shown in the figure, the ribbons have windows 32 cut out in said ribbons and each presenting a closed outline. As explained below, the ribbons are cut apart from label strips, and the windows 32 are cut out in the strips. FIG. 1 thus shows two label strips 34 each having a windowing station 36 placed on its path and in which the windows are cut out. It should be pointed out that two label strips 34 are shown in order to make the drawing easier to read, corresponding to the two rows R1 and R2 of thermoforming chambers. However, it is possible to make the various ribbons from a single label strip, in which case a single windowing station 36 is sufficient, as shown in particular in patent FR 2 790 705.

There follows a description of FIG. 7, which shows a container of the invention. This container comprises a body 1 and a label 2, which in this example is made in the form of a band that surrounds the body 1. Said body presents an edge 1A defining an opening. As described with reference to FIG. 1, product may be poured into the container via the opening 1, before a lid is placed on the edge, in particular in the form of a sealed cover.

As can be seen in FIG. 7, the label 2 has a window 32 through which there can be seen a portion 3 of the body of the container 3. This portion 3 presents decoration 3A that is thus made visible. It can be seen that the window 32 has a closed outline, as mentioned above. It can also be seen that the decoration 3A of the body of the container comprises an image in relief, e.g. of the logo type, or the like. In this example, the window is circular, but, naturally, other shapes of window may be imagined.

With reference to FIGS. 2 and 3, there follows a description of the windowing tool that makes it possible to make windows 32. In FIGS. 2 and 3, this tool is shown diagrammatically and as seen looking in a direction that is relative to the direction of advance of the label strip 34.

Thus, FIGS. 2 and 3 show the label strip 34, with rollers or wheels 38 that ensure it is driven through the windowing station 36. Said station comprises a windowing tool 37 made in the form of a punch that is movable downwards and upwards in a guide sleeve 36A. The windowing tool also comprises a backing tool 36B placed on the other side of the strip 34 relative to the sleeve 36A. If needed, the sleeve 36A and/or the backing tool 36B may be movable a little downwards and upwards perpendicularly to the plane of the label strip 34 in order to be able to grip it while the windows are being cut out.

A container 40 is placed under the windowing station 36 in order to collect the cut-out label portions 33. In FIG. 2, the cutting punch is in a retracted position, and the label strip 34 moves forwards one step in order to be ready for cutting out a new window, a preceding window 32 having just been cut out. In FIG. 3, the window is being cut out, the cutting punch 37 having passed through the strip in order to reach the inside of the backing tool, said tool being suitable for being formed by a ring, whereas the sleeve may be cylindrical.

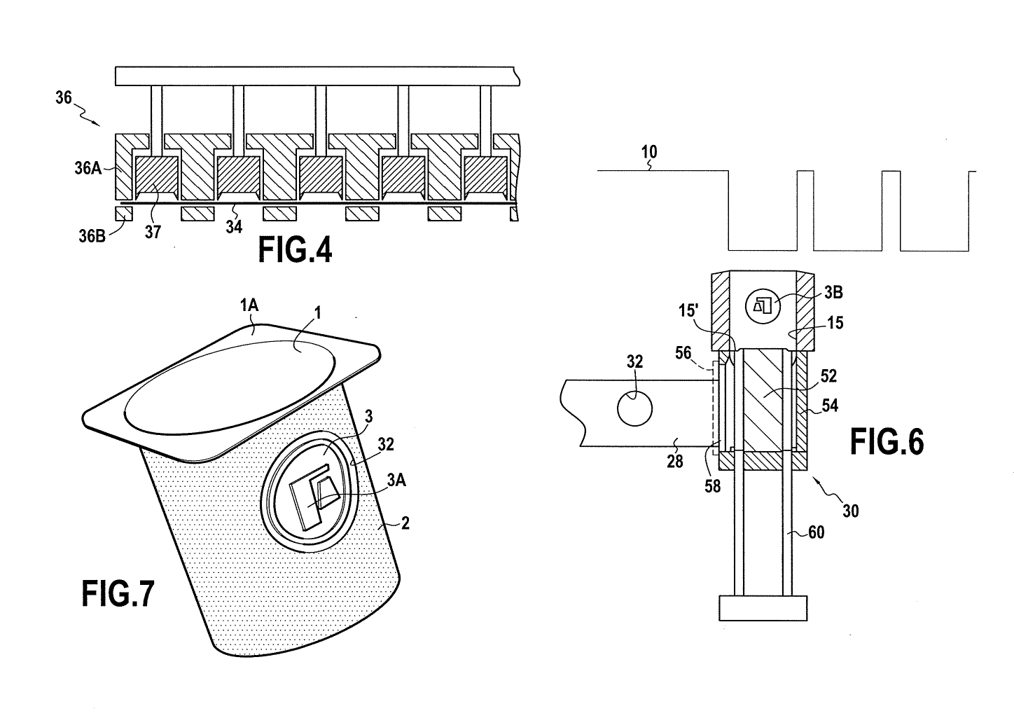

FIG. 4 shows the windowing station, with a row of windowing tools oriented transversely relative to the direction of advance F of the label strip 34. This FIG. 4 view is therefore transverse relative to FIGS. 2 and 3.

FIG. 5 is a diagram showing the cutting punch 37. It presents a cylindrical wall 37B guiding its sliding in the sleeve 36A, and a cutting edge 37A that cuts out the windows 32. Specifically, this edge 37A is of annular shape and defines a recess 37C in the front face of the punch 37.

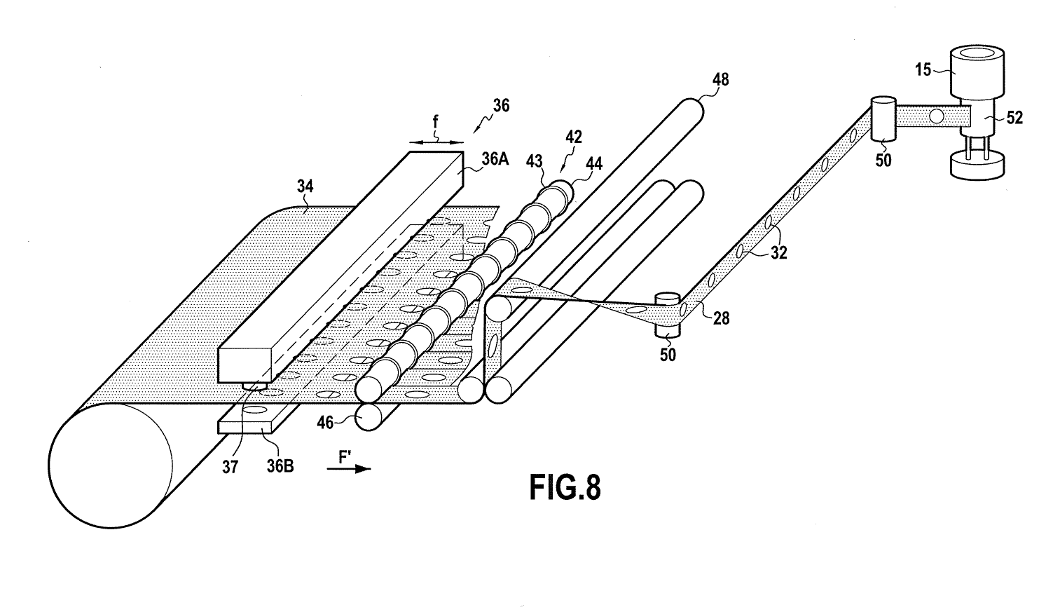

There follows a description of FIG. 8, which shows the windows 32 being made in the banding ribbons. This figure shows the label strip 34, unwound from a roller and moved forwards in the direction F, generally in a horizontal plane. In order to make the ribbons from said strip, the installation includes splitting means comprising blades having cutting edges that are oriented parallel to the direction of advance of the strip. In this example, the blades 43 are formed on the annular projections placed on a splitting roller 44, cooperating with a backing roller 46 placed on the other side of the label strip. Thus, a row of ribbons 28 is formed by splitting the label strip 34. For reasons of clarity in the drawing, most of the ribbons are omitted, such that only one of the ribbons is shown as far as the station for inserting it into thermoforming chamber.

Upstream from the splitting means, the installation includes the windowing station 36 in which the windows 32 are made. As mentioned with reference to FIG. 4, all the windows of a single row are made simultaneously.

Downstream from the above-described splitting means, the ribbons are conveyed towards the thermoforming chambers. Although the means for feeding the label strip 34 and the ribbons 28 are not shown in full, FIG. 8 shows conveyer rollers 48 and angle deflector rollers 50 that enable the ribbons to be presented in vertical planes when they reach the region of the thermoforming chambers. In order to place the ribbons in the thermoforming chambers, it is possible to use means analogous to those described in Document FR 2 790 705 for example. In order to simplify the drawings, FIG. 8 shows only the outer wall of a thermoforming chamber 15, and a core 52 about which the end of the ribbon 28 may be wound before being cut flush with the opening of the winding chamber in which said core is located. This is also shown in FIG. 6, in which the roller 52 is shown placed in the winding chamber 54, the wall of said chamber being omitted in FIG. 8 in order to simplify the drawing. In other words, an end segment of the ribbon is wound around the winding core 52, and said end segment is cut flush with the opening slot 58 of the winding chamber. The cutting tool 56 is shown diagrammatically in FIG. 6 and is not shown in FIG. 8. It may be as described in Document FR 2 790 705.

Thus, the means for inserting the band into the chamber include a slot 15′ formed at the base of said chamber (corresponding to the space between the core 52 and the wall of the winding chamber 54) and pusher fingers 60 that are shown in the retracted position in FIG. 6, and that can be moved towards the base of the chamber in order to push the band through the slot 15′.

FIG. 6 shows a thermoforming chamber 15 above which there are placed in the winding chamber 54 means for inserting ribbons in the chamber 15. The figure shows that the wall of the chamber 15 presents a pattern in relief 3B that is the negative of the pattern 3A of the body of the container of FIG. 7.

The thermoplastic material in which the containers are formed, as well as the label strip and the ribbons that are split therefrom, are moved forwards stepwise through the installation. Naturally, the means for imparting forwards stepwise movement are operated synchronously in register. In addition, the windows 32 in the bands 28 are positioned relative to the length of a band, so as to be placed around the pattern in relief 3B on the wall of the thermoforming chamber when the band is in place in said chamber. In order to facilitate such registration, the windowing tool 37 is advantageously movable so that its position can be adjusted as represented by double arrow f, so as to position the windows 32 in register as desired. In the example shown, the windowing station is movable as a whole.

The pattern in relief 3B on the inside wall of the thermoforming chamber 15 may be made in a fitted part, e.g. a liner, which is placed in said chamber. It may be a removable part in order to be able to change the decoration of the body of the container, and for reasons of maintenance. Since the containers have cylindrical bodies, it may also be envisaged that the pattern in relief is carried by a sleeve that can be turned about the axis of the chamber in order to facilitate positioning the relief 3B in register relative to the windows 32 of the bands.

1. A container comprising a container body and a label placed on said container body,
the label having a window through which there can be seen an image in relief forming decoration on the container body.

2. A container as claimed in claim 1, wherein the body is thermoformed.

3. A container according to claim 1, wherein the label is a band that surrounds the container body.

4. A container as claimed in claim 1, wherein the window has a closed outline.

5. A method of manufacturing containers provided with a decorative label, wherein at least one container body is formed by thermoforming in a thermoforming chamber and a label is affixed on said body, wherein before affixing the label on the container body, a window is cut out in the label, and then the label is affixed in such a manner that a portion of the body is visible through said window, and decoration is made on said portion of the container body by a pattern in relief provided on a wall of said chamber.

6. A method as claimed in claim 5, wherein, before the container body is formed, the label having the cut-out window is placed in said chamber.

7. A method as claimed in claim 5, wherein the label is made in the form of a looped band cut from a ribbon.

8. A method as claimed in claim 5, wherein a thermoforming mold is provided that has at least one row of thermoforming chambers, a label having a cut-out window is placed in each of the chambers of the row, and a container body is thermoformed in each of the chambers provided with a cut-out label.

9. A method as claimed in claim 8, wherein, while feeding a label strip to the thermoforming mold, at least one row of windows is cut out from the label strip, the label strip is cut apart into at least one row of ribbons each having one window of the row of windows, and a respective ribbon of the row of ribbons is fed to each of the thermoforming chambers of the row of chambers, and in that, for each ribbon of the row of ribbons, an end segment having a window is cut off and said segment is placed in a respective chamber of the row of chambers.

10. An installation for manufacturing containers provided with respective decorative labels, the installation comprising at least one thermoforming chamber for forming the body of at least one container;
a windowing tool suitable for cutting out a window in a label before the label is affixed on the body, and a wall of the thermoforming chamber being provided with a pattern in relief that forms a corresponding decoration in relief on the body of the container during thermoforming of the latter, said decoration being visible through the window of the label.

11. An installation as claimed in claim 10, wherein the label is placed in the thermoforming chamber, before thermoforming of the container body, the label being placed against the wall of the thermoforming chamber so that the pattern in relief is positioned in the window.

12. An installation as claimed in claim 11, comprising a feeder for feeding a label ribbon to the thermoforming chamber along a feed path, the windowing tool being placed on the feed path and the installation comprising, downstream from said windowing tool, a tool for cutting off an end segment from the label ribbon before said segment is placed in the thermoforming chamber.

13. An installation according to claim 12, comprising a thermoforming mold having at least one row of thermoforming chambers, a splitter configured to cut apart at least one row of ribbons from a label strip driven in the installation, and a windowing station comprising at least one row of windowing tools, the windowing station being placed upstream from the splitter.
